(19) United States
(12) Patent Application Publication
(10) Pub. No.: US 2010/0276174 A1
(43) Pub. Date: Nov. 4, 2010

(54) FLEXIBLE ELECTRICAL CABLE

(76) Inventors: Ferdinand Grögl, Nurnberg (DE); Harry Popp, Nurnberg (DE)

Correspondence Address: SOFER & HAROUN LLP., 317 MADISON AVENUE, SUITE 910, NEW YORK, NY, 10017, US

(21) Appl. No.: 12/607,307

(22) Filed: Oct. 28, 2009

(30) Foreign Application Priority Data
Nov. 12, 2008 (EP) 08291053.0

(51) Int. Cl. H01B 9/02

(52) U.S. Cl. 174/105 R

(57) ABSTRACT

A flexible electrical cable having a centre part surrounded by a sheath (16) made of insulating material is specified in which are arranged at least one data pair (DP) consisting of two data cores (1, 2) which are used for data transmission and are surrounded by a common screen containing a metallized synthetic fleece, and at least one supply core (VA) which is used for supplying power, which are surrounded by a common electrical screen (15). In the centre part, at least two screened data pairs (DP) with data cores (1, 2) running parallel to one another are arranged separately from one another, the screen of which has a synthetic-material-clad metal foil (5) surrounding said screen on all sides, the metal side of which faces outwards, over which the metallized synthetic fleece (6) is arranged in contact with the metal side. At least one supply core (VA) is present in the centre part, and data pairs (DP) and supply cores (VA) are twisted around a central spine (8) which is resistant to tensile forces and is easily bendable, the supply core (VA) being arranged between the data pairs (DP).

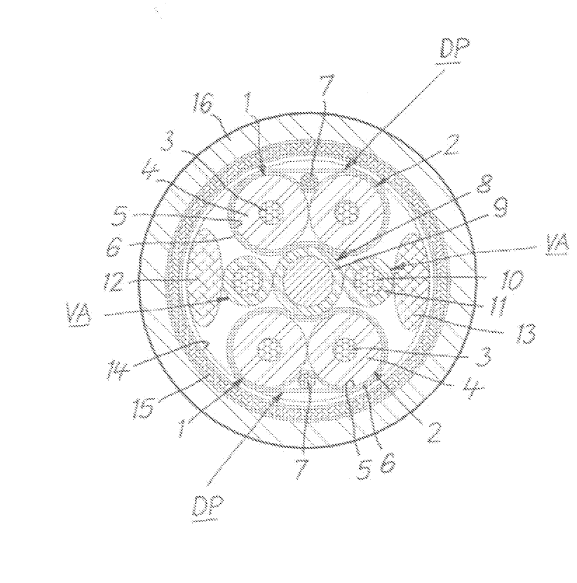

### RELATED APPLICATION

This application claims the benefit of priority from Eu No. 08291053.0, filed on Nov. 12, 2008, the entirety of which is incorportaed by reference.

### BACKGROUND

1. Field of the Invention

The invention relates to a flexible electrical cable having a centre part surrounded by a sheath made of insulating material in which are arranged at least one data pair consisting of two data cores which are used for data transmission and are surrounded by a common screen containing a metallized synthetic fleece, and at least one supply core which is used for supplying power, which are surrounded by a common electrical screen over which the sheath is arranged, the data cores and the supply core each having an electrical conductor which is surrounded by an insulator (EP 1 589 541 B1).

2. Description of Related Art

Cables of this kind are used, for example, in automobile engineering in so-called driver assistance systems. They must be capable of being mechanically loaded and in particular resistant to tensile forces, with good flexibility which remains constant over a long period. They must also guarantee fault-free transmission of data at the highest possible data rates.

With the known cable according to EP 1 589 541 B1 mentioned in the introduction, the insulation of the two signal cores which are twisted together consists of expanded insulating material. An electrically conducting, metallized synthetic fleece is continuously formed around the signal cores as a screen. A supply core is arranged in each case in the two opposing interstices between the two signal cores outside the screen, and at least one drain wire made from good electrically conducting metallic wires is positioned next to at least one of the supply cores. A common outer screen made from an electrically conducting, metallized synthetic fleece is fitted over the unit comprising signal cores, supply cores and drain wire, and the outer screen is surrounded by a screen layer made from good electrically conducting metallic wires over which the sheath is arranged. This cable has proven its worth in practice. However, it is not particularly resistant to tensile forces and its use is restricted to relatively low data rates.

The invention is based on the object of designing the cable described in the introduction so that it can also be used for high data rates in the frequency range of 1 GHz without interference while at the same time having improved mechanical characteristics.

According to the invention, this object is achieved in that
in the centre part, at least two screened data pairs with data cores running parallel to one another are arranged separately from one another, the screen of which has a synthetic-material-clad metal foil surrounding said screen on all sides, the metal side of which faces outwards, over which the metallized synthetic fleece is arranged in contact with the metal side,
at least one supply core is present in the centre part, and
data pairs and .supply cores are twisted around a central spine which is resistant to tensile forces and is easily bendable, the supply core being arranged between the data pairs.

This cable can be produced with conventional technology using fundamentally known simply constructed machines and associated fixtures. Because of the central spine, it has outstanding mechanical characteristics, in particular a tensile strength which is necessary for many applications. As the spine, which is resistant to tensile forces, is easily bendable and the other elements of the cable are twisted around said spine, the overall cable is easily bendable. The data pairs are in each case surrounded by a screen which screens the respective transmission circuits very well against interference radiated from outside, namely also for very high frequencies or data rates. This screening, which is effective for frequencies of 1.2 GHz for example, is achieved by the interaction of the metal foil which is closed on all sides and the metallized synthetic fleece which is likewise an almost closed metallic sleeve with a covering>85% for the data pairs. The screening so formed also prevents interference being radiated from the data pairs which could mutually interact or which could also be effective outside the cable. A further advantage of this cable is that there are no run-time differences in the data transmission on the data pairs, as the data cores run parallel to one another and are therefore of equal length.

### BRIEF DESCRIPTION OF THE DRAWING:

An exemplary embodiment of the subject matter of the invention is shown in the drawing.

The only FIGURE of the drawing shows a cross section of a cable according to the invention.

### DETAILED DESCRIPTION:

The cable shown in cross section in the drawing has two data pairs DP in each of which two data cores 1 and 2 are arranged running parallel to one another. Each data core 1 and 2 respectively has a conductor 3 preferably made of copper which is surrounded by an insulation 4. The conductor 3 can be a solid wire or with advantage a stranded conductor. It can have an external layer of tin, silver or nickel. The conductor 3 can also consist of a cadmium-free copper alloy. With advantage, the insulation 4 consists of expanded insulating material such as polyethylene or polypropylene for example. An insulating material suitable for high temperatures can also be used such as polytetrafluoroethylene (PTFE), fluoroethylenepropylene (FEP) or polyfluoroalkene (PFA) for example. An expanded insulation 4 can be provided with a smooth outer skin in known “skin” technology. With advantage, the insulation 4 consists of a low-density PTFE and, if necessary, of a sintered “skin” layer of PTFE or of extruded FEP or PFA. It can also be made up of three layers of the given materials in the order skin-foam-skin. Such a structure of the insulation 4 enables its secure seating on the respective conductor to be increased.

The two data cores 1 and 2 are not twisted together but run parallel to one another with equal length. A common screen, which consists of a synthetic-material-clad metal foil 5 and an electrically conducting metallized synthetic fleece 6, is fitted over the data cores 1 and of each data pair DP. The synthetic-material-clad metal foil 5—referred to in the following as “metal foil 5” for short—has a synthetic material side made from polyester, for example, and a metal side preferably made from aluminium or copper. It is preferably longitudinally formed around the data cores 1 and 2 while forming an overlapping point which runs in the longitudinal direction, and thus forms a metal sleeve which surrounds said data cores on all sides. At the same time, the metal side of the metal foil 4 faces the outside. The metallized synthetic fleece 6 is provided, for example, in the form of a strip which is wound around the metal foil 5 with an overlap. With advantage, the overlap lies between 20% and 50%. In order to reduce or suppress a possible signal radiation in the overlapping region of the metal foil 5 particularly at very high frequencies, said metal foil can be provided on all sides with an additional metal film made of silver for example.

In a preferred embodiment, the synthetic fleece 6 is made of polyester fibres. However, it can also be made of other suitable synthetic fibres which with advantage are resistant to high temperatures. Examples of such materials are polyaramid and polyimide. The wall thickness or thickness of the synthetic fleece 6 preferably lies between 50 μm and 300 μm. A good electrically conducting metal is used for its metallization, in particular aluminium, copper, silver, nickel or a cadmium-free copper alloy. Two or more different metals, which can be applied one after the other, can also be used to improve the resistance of the synthetic fleece 6 to corrosion. The metal is converted to the molten state for metallization and deposited on the fleece material from the vapour phase. In doing so, the metal also penetrates into the fleece material and surrounds the fibres which are held together there in a disorderly manner. Overall, a metal film is produced on and in the synthetic fleece, which although it is porous is almost completely closed and which gives a coverage of>85% for the data cores 1 and 2 which are already enclosed by the metal foil 5.

In a preferred embodiment, a drain wire 7 made from a good electrically conducting material is fitted between the metal foil 5 and the synthetic fleece 6 in each case. In particular, it is made of copper and can additionally be coated with tin, silver or nickel for corrosion protection. With advantage, the drain wire 7 can lie in one of the interstices between the data cores 1 and 2, the metal foil 5 being pressed into the respective interstice. It serves mainly to provide a reliable longitudinal contact of the mechanically sensitive metal foil 5.

The two data pairs DP are arranged on mutually opposite sides of a central spine 8 of the cable which is resistant to tensile forces and is easily bendable. In a preferred embodiment, it is designed in the form of steel cable and is surrounded by a layer 9 of insulating material which, for example, is made of polyurethane, a thermoplastic elastomer or a high-temperature-resistant plastic. The spine 8 can however also be made from a fibre-reinforced plastic or from high-strength synthetic yarns, for example aramid yarns.

A supply core VA, which in each case consists of a conductor 11 surrounded by an insulation 10, is arranged in each case between the two data pairs DP on both sides of the spine 8. The two data pairs DP and the two supply cores VA are twisted around the spine 8, with advantage without twisting the data pairs DP in the opposite direction. Two fillers 12 and 13 made from insulating material are provided to give the centre part of the cable consisting of spine 8, data pairs DP and supply cores VA an approximately circular cross-sectional shape.

The centre part of the cable can be surrounded overall by a winding 14 made from insulating material which is preferably formed by winding of a strip of polyester fleece or other high-temperature-resistant synthetic material. A common electrical screen 15 is arranged over the winding 14. With advantage, the screen 15 has a synthetic-material-clad metal foil, which can also be designed in the same way as the metal foil 5, surrounding the winding 14. It is wound continuously, for example, around the winding 14 with the metal side facing outward. As a further element of the screen 15, a braid made from corrosion-protected copper wires or a metallized synthetic fleece whose structure is the same as the synthetic fleece 6 can be fitted over this metal foil. A braid made from corrosion-protected copper wires can also be used instead of the metal foil.

For special applications, a potential isolation of the screens of the data pairs DP and the common screen 15 may not be necessary. The winding 14 around the centre part of the cable is then omitted so that the screens of the data pairs DP have direct contact with the screen 15 which then has a metallic inner layer.

The outer sheath 16 of the cable, which is preferably produced by extrusion, is arranged over the screen 15. With advantage, it is made of polyurethane or a thermoplastic elastomer.

As a variation from the embodiment described, the cable can also have more than two data pairs DP which are twisted separately from one another around the spine 8. It has at least one supply core VA. According to the diagrammatic representation, there can also be two supply cores VA or more than two supply cores. With advantage, the supply cores VA lie separately from one another between two data pairs DP in each case in all embodiments. All these “twisting elements” are twisted together around the spine 8.

1. Flexible electrical cable comprising:
a centre part surrounded by a sheath made of insulating material in which are arranged at least one data pair having two data cores which are used for data transmission and are surrounded by a common screen containing a metallized synthetic fleece, and at least one supply core which is used for supplying power, which are surrounded by a common electrical screen over which the sheath is arranged, the data cores and the supply core each having an electrical conductor which is surrounded by an insulator, wherein
in the centre part, at least two screened data pairs with data cores running parallel to one another are arranged separately from one another, the screen of which has a synthetic-material-clad metal foil surrounding said screen on all sides, the metal side of which faces outwards, over which the metallized synthetic fleece is arranged in contact with the metal side,
at least one supply core is present in the centre part, and
data pairs and supply cores are twisted around a central spine which is resistant to tensile forces and is easily bendable, the supply core being arranged between the data pairs.

2. Cable according to claim 1, wherein the synthetic-material-clad metal foil is provided on all sides with an additional metal film, preferably with a silver film.

3. Cable according to claim 1, wherein the metallized synthetic fleece is designed in the form of a strip and is wound around the synthetic-material-clad metal foil with an overlap between 20% and 50%.

4. Cable according to one of claim 1, wherein a metallic drain wire is arranged between synthetic-material-clad metal foil and metallized synthetic fleece for each data pair.
